(19) United States
(12) Patent Application Publication
(10) Pub. No.: US 2013/0120734 A1
(43) Pub. Date: May 16, 2013

(54) LASER RADAR APPARATUS

(71) Applicants: Tetsuya Ogata, Tokyo (JP); Mitsuru Nakajima, Kanagawa (JP); Shuichi Suzuki, Kanagawa (JP); Kenichi Yoshimura, Kanagawa (JP); Akihiro Iwamatsu, Kanagawa (JP); Kohei Shimizu, Kanagawa (JP); Tokiko Inoue, Tokyo (JP); Chihiro Tanaka, Kanagawa (JP)

(72) Inventors: Tetsuya Ogata, Tokyo (JP); Mitsuru Nakajima, Kanagawa (JP); Shuichi Suzuki, Kanagawa (JP); Kenichi Yoshimura, Kanagawa (JP); Akihiro Iwamatsu, Kanagawa (JP); Kohei Shimizu, Kanagawa (JP); Tokiko Inoue, Tokyo (JP); Chihiro Tanaka, Kanagawa (JP)

(21) Appl. No.: 13/650,382

(22) Filed: Oct. 12, 2012

(30) Foreign Application Priority Data
Nov. 11, 2011 (JP) 2011-247884

(51) Int. Cl. G01S 17/02

(52) U.S. Cl. 356/4.01

(57) ABSTRACT

A laser radar apparatus includes a light source; a light scanning unit configured to scan light irradiated from the light source; a light receiving unit configured to receive light that is reflected by an object, the light being irradiated from the light scanning unit onto the object and reflected by the object; and a porous member arranged between the object and the light receiving unit, the porous member including plural through holes.

### BACKGROUND OF THE INVENTION

1. Field of the Invention

The disclosures herein generally relate to a laser radar apparatus.

2. Description of the Related Art

An object type determining apparatus is known that uses a scanning laser radar apparatus installed in a vehicle to detect preceding vehicles and obstacles on the road and/or lane markers such as white lines and cat's eyes. The laser radar apparatus may detect a preceding vehicle or an obstacle that is ahead of the vehicle by irradiating laser light in a forward direction ahead of the vehicle and receiving the laser light reflected by the preceding vehicle or obstacle.

FIG. 1 is a block diagram showing an exemplary configuration of a scanning laser radar apparatus. The scanning laser radar apparatus shown in FIG. 1 includes a light transmitting unit 910, a light receiving unit 920, and an ECU (electronic control unit) 930. The light transmitting unit 910 and the light receiving unit 920 are arranged at the front side of the vehicle so that objects located ahead of the vehicle may be detected.

The light transmitting unit 910 includes a semiconductor laser diode (referred to as “LD” hereinafter) 911 that irradiates pulsed laser light, an optical scanner 912, an input optical system 913 that guides the light from the LD 911 to the optical scanner 912, and an output optical system 914 that controls the tilt angle from the road surface of a light beam that has passed the optical scanner 912, for example. The LD 911 is connected to the ECU 930 via a LD drive circuit 915 and is configured to irradiate laser light according to an LD drive signal from the ECU 930. The optical scanner 912 is connected to the ECU 930 via an optical scanner drive circuit 916 and is configured to repetitively scan the light beam irradiated from the LD 911 in the horizontal direction at a predetermined frequency based on a light scanning drive signal from the ECU 930. The scanning angle of the light beam irradiated from the optical scanner 912 is detected by a scanning angle monitor 917 and is output to the ECU 930 as a scanning angle signal. By supplying the scanning angle signal as feedback for the light scanning drive signal, the scanning angle and the scanning frequency may be controlled.

The light receiving unit 920 includes a light receiving lens 921 and a light receiving element 922. Laser light reflected by an object located ahead of the vehicle enters the light receiving element 922 via the light receiving lens 921 and a mirror element (not shown), for example. The light receiving element 922 may be a photodiode, for example, and is configured to output an electric signal with a voltage corresponding to the intensity of the reflected light entering the light receiving element 922. The electric signal output by the light receiving element 922 is amplified by an amplifier 941 and output to a comparator 942. The comparator 942 compares the output voltage of the electric signal from the amplifier 941 with a reference voltage V0 and outputs a predetermined light receiving signal to a time measuring circuit 943 when the output voltage is greater than the reference voltage V0.

The time measuring circuit 943 also receives the LD drive signal that is output to the LD drive circuit 915 from the ECU 930 and outputs the time difference between the time point at which the laser light is irradiated and the time point at which the reflected light is received as time measurement data to the ECU 930. Based on the time measurement data, the ECU 930 may calculate the distance of the object from the laser radar apparatus. It is noted that the LD 911, the optical scanner 912, the input optical system 913, the output optical system 914, and the scanning angle monitor 917 may be referred to as a light irradiating unit 950.

In the above scanning laser radar apparatus, the optical scanner 912 of the light transmitting unit 910 may include a polygon mirror or a galvano mirror, for example.

FIG. 2 is a diagram showing an exemplary configuration of the light irradiating unit 950 and the light receiving unit 920 of the scanning laser radar apparatus. In FIG. 2, the LD 911 and the input optical system 913, which may be a collimator lens, for example, are arranged at the side of the optical scanner 912 including a scanning mirror 961 such as a polygon mirror. Laser light irradiated from the LD 911 is irradiated on the mirror surface of the scanning mirror 961 of the optical scanner 912 via the input optical system 913. The scanning mirror 961 rotates around a rotational axis 962 while light irradiated on the mirror surface of the scanning mirror 961 of the optical scanner 912 is reflected by the mirror surface so that a laser beam may be scanned over a wide range in the horizontal direction. In this way, distance measurement over a wide region may be possible.

When light irradiated from the scanning laser radar apparatus is irradiated on an object 970, the light is reflected and scattered by the object 970. A part of the scattered light reflected by the object 970 is collected by the light receiving lens 921 and the collected light then enters the light receiving element 922 so that the light is detected by the light receiving element 922.

When the object 970 is located far away, only a small amount of the scattered light reflected by the object 970 may enter the light receiving lens 921. Japanese Patent No. 3621817 discloses the use of an avalanche photodiode (APD) with high light sensitivity as the light receiving element 922 so that even a small amount of light may be detected. The APD generally has lower noise than a PIN type photodiode (referred to as “PD” hereinafter) and has high light sensitivity. Also, the light sensitivity of the APD may be arbitrarily set by adjusting the bias voltage to be applied. That is, the light sensitivity may be heightened by raising the bias voltage, and the light sensitivity may be lowered by lowering the bias voltage. Thus, by setting the bias voltage of the APD at a high voltage, even a small amount of scattered light may be accurately detected.

FIGS. 3A and 3B are diagrams illustrating different light intensities of scattered light received by the light receiving lens 920 from objects located at different distances from the scanning laser radar apparatus. FIG. 3A shows the intensity of scattered light If entering the light receiving lens 921 when an object 970f is located relatively far away from the scanning laser radar apparatus. FIG. 3B shows the intensity of scattered light In entering the light receiving lens 921 when an object 970n is located relatively close to the scanning laser radar apparatus. As is shown in FIGS. 3A and 3B, the light irradiated from the scanning laser radar apparatus and reflected by the objects 970f, 970n scatters in various directions. The relationship between the intensity of the scattered light If of FIG. 3A and the intensity of scattered light In may be represented as follows: In intensity>If intensity.

FIG. 4 is a graph illustrating output signals of the light receiving element 922 of the scanning laser radar apparatus when objects located at different distances from the scanning laser radar apparatus are detected. As is shown in FIG. 4, a high output signal Vn is output for the scattered light In from the object 970n that is located at a short distance Xn from the scanning laser radar apparatus whereas a low output signal Vf is output for the scattered light If from the object 970f that is located at a long distance Xf from the scanning laser radar apparatus. In this case, the output signal Vn may overlap the output signal Vf thereby making it difficult to measure the time difference for each of the output signals. As a result, the time analysis performance and the distance measurement accuracy of the laser radar apparatus may be degraded. It is noted that the c denotes the speed of light, c/(2×n) represents the time it takes for the light irradiated from the light irradiating unit 950 to be detected at the light receiving element 922 when the object 970n is located at a short distance Xn, and c/(2×f) represents the time it takes for the light irradiated from the light irradiating unit 950 to be detected at the light receiving element 922 when the object 970f is located at a long distance Xf.

Japanese Laid-Open Patent No. 2008-20204 discloses a radar apparatus that uses both a PD and an APD as light receiving elements. In this case, the scattered light entering the light receiving lens is bifurcated and the scattered light from an object located closer is detected by the PD whereas the scattered light from an object located farther is detected by the APD. In this way, the output signals may be prevented from leaking into each other so that the time analysis performance and the distance measurement accuracy of the radar apparatus may be improved.

However, since the scattered light entering the light receiving lens is bifurcated at the above radar apparatus, the absolute amount of light entering each of the light receiving elements (i.e., PD and APD) is decreased so that the bias voltage needs to be set at a higher level in order to secure a certain amount of the output signal voltage. This in turn may lead to an increase in shot noise.

Also, since two light receiving elements are used in the above radar apparatus, elements such as a collecting lens, an amplifier, and an A/D converter are required for each of the light receiving elements. This may lead to a complicated apparatus structure and an increase in the cost of the radar apparatus.

### SUMMARY OF THE INVENTION

It is a general object of at least one embodiment of the present invention to provide a laser radar apparatus that substantially obviates one or more problems caused by the limitations and disadvantages of the related art.

According to one embodiment of the present invention, a laser radar apparatus includes a light source; a light scanning unit configured to scan light irradiated from the light source; a light receiving unit configured to receive light that is reflected by an object, the light being irradiated from the light scanning unit onto the object and reflected by the object; and a porous member arranged between the object and the light receiving unit, the porous member including plural through holes.

According to an aspect of the present invention, a laser radar apparatus may be capable of simultaneously detecting an object located at a short distance and an object located at a long distance, may be low in cost, and may be capable of performing accurate distance measurements.

### BRIEF DESCRIPTION OF THE DRAWINGS

Other objects and further features of embodiments will be apparent from the following detailed description when read in conjunction with the accompanying drawings, in which:

FIG. 1 is a block diagram showing an exemplary configuration of a scanning laser radar apparatus;

FIG. 2 is a diagram showing an exemplary configuration of a light irradiating unit and a light receiving unit of the scanning laser radar apparatus;

FIGS. 3A and 3B are diagrams illustrating different light intensities of scattered light received by a light receiving lens from objects located at different distances from the scanning laser radar apparatus;

FIG. 4 is a graph illustrating output signals of the light receiving element of the scanning laser radar apparatus when objects located at different distances from the scanning laser radar apparatus are detected;

FIG. 5 is a block diagram showing a configuration of a scanning laser radar apparatus according to a first embodiment of the present invention;

FIG. 6 is a perspective view of a porous member of the laser radar apparatus according to the first embodiment;

FIG. 7 is a plan view of the porous member of the laser radar apparatus according to the first embodiment;

FIGS. 8A and 8B are diagrams illustrating scattered light from an object that is located relatively far away from the laser radar apparatus of the present embodiment;

FIGS. 9A and 9B are diagrams illustrating scattered light from an object that is located relatively close to the laser radar apparatus of the present embodiment;

FIGS. 10A and 10B are diagrams illustrating scattered light from an object that is located at an intermediate distance from the laser radar apparatus according to the present embodiment;

FIGS. 11A and 11B are a cross-sectional view and a plan view of a through hole of the porous member when scattered light enters the porous member;

FIG. 12 is a graph showing the relationship between the incidence angle and the passing light intensity of scattered light;

FIG. 13 is a graph showing output signals of a light receiving element of the laser radar apparatus according to the present embodiment when objects located at different distances are detected;

FIG. 14 is a plan view of a porous member used in a laser radar apparatus according to a second embodiment of the present invention;

FIG. 15 is a plan view of a porous member used in a laser radar apparatus according to a first modification of the second embodiment;

FIG. 16 is a perspective view of the porous member used in the first modification;

FIG. 17 is a graph showing the relationship between the incidence angle and the passing light intensity of scattered light in the laser radar apparatus according to the first modification;

FIG. 18 is a plan view of a porous member used in a laser radar apparatus according to a second modification of the second embodiment; and

FIG. 19 is a side view of a porous member used in a laser radar apparatus according to a third modification of the second embodiment.

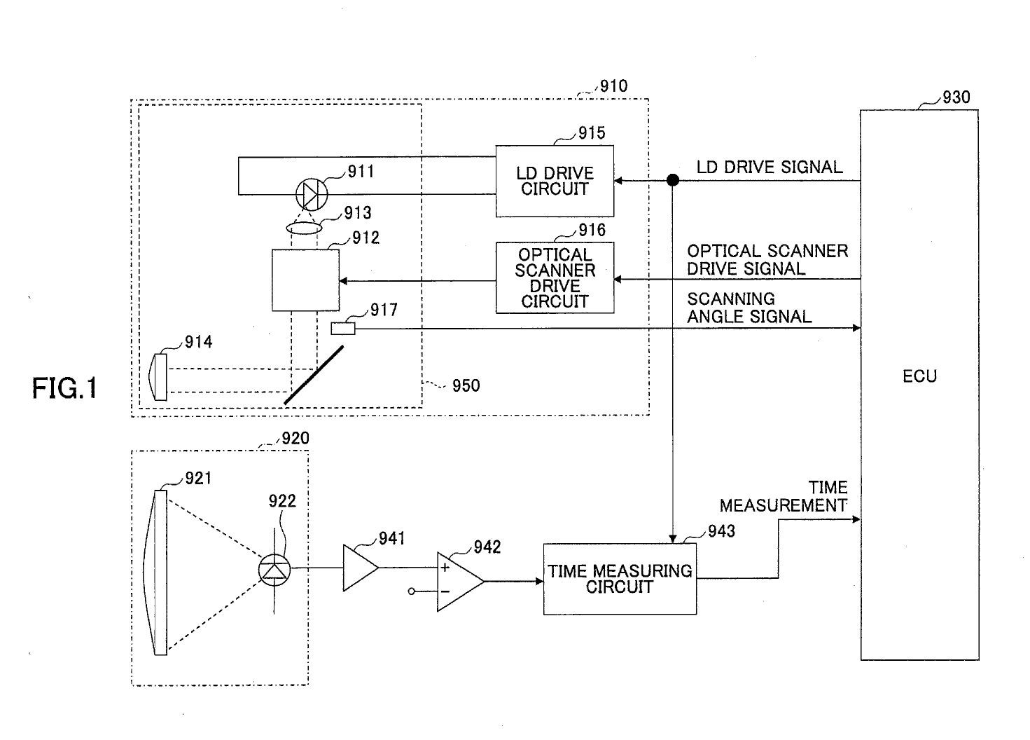

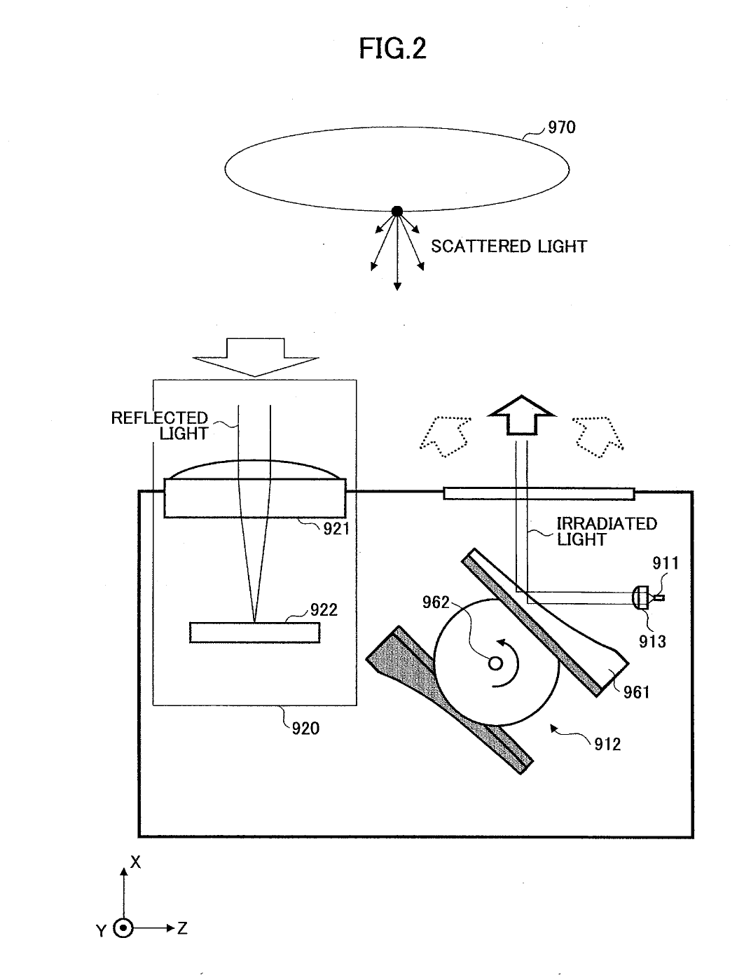

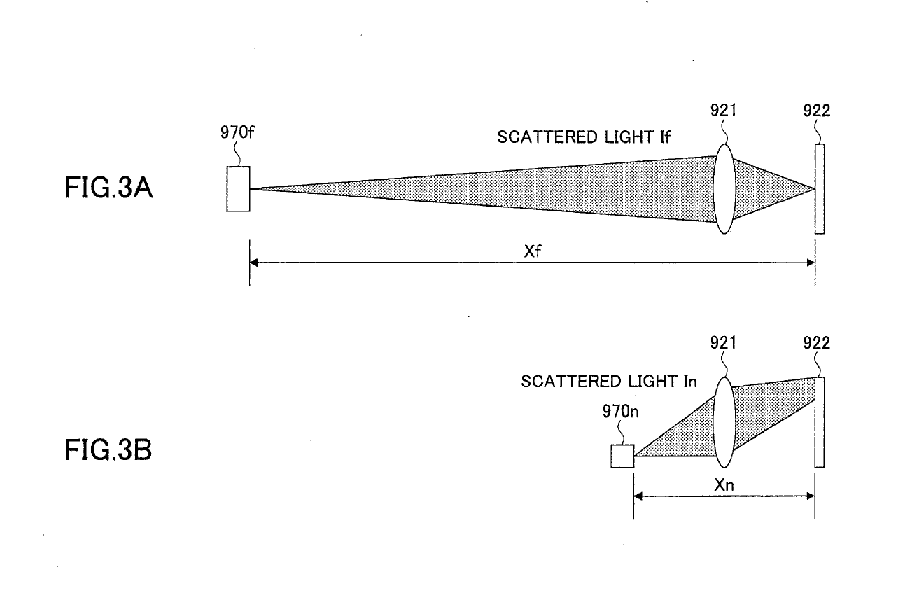

### DESCRIPTION OF THE PREFERRED EMBODIMENTS

In the following, embodiments of the present invention are described with reference to the accompanying drawings.

### First Embodiment

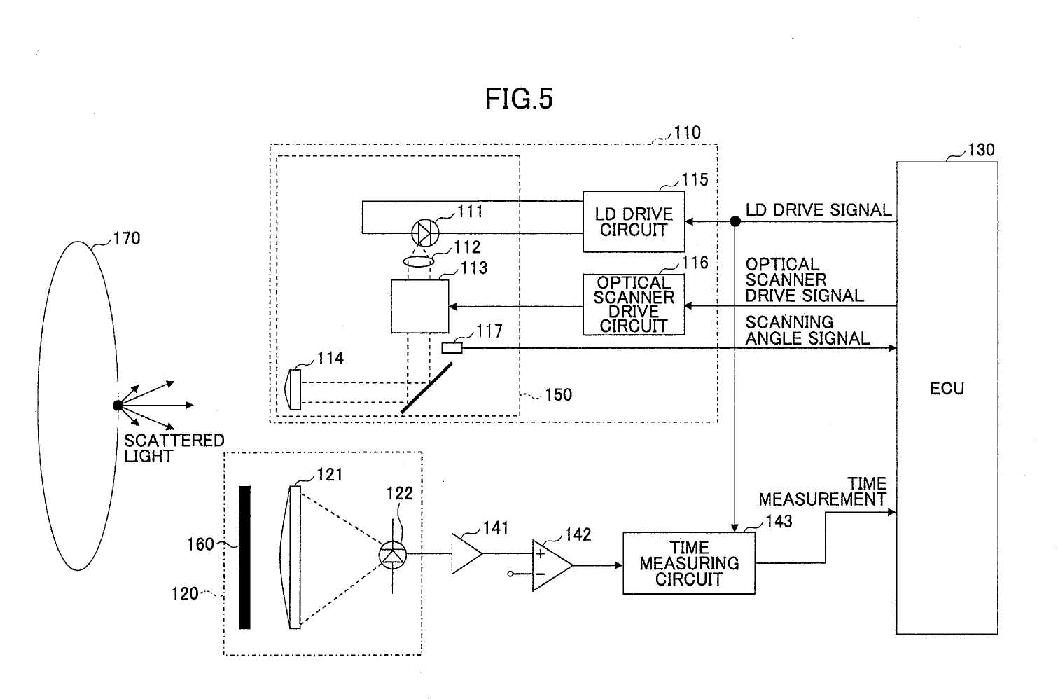

FIG. 5 is a block diagram showing a configuration of a scanning laser radar apparatus according to a first embodiment of the present invention.

A laser radar apparatus according to the present embodiment includes a light transmitting unit 110, a light receiving unit 120, and an ECU 130. The light transmitting unit 110 and the light receiving unit 120 are arranged at the front side of a vehicle such as a car so that an object located ahead of the vehicle may be detected.

The light transmitting unit 110 includes a light source (referred to as “LD” hereinafter) 111, which includes a semiconductor laser diode that irradiates pulsed laser light, an optical scanner 112, an input optical system 113, which may be a collimator lens, for example, that guides light from the light source 111 to the optical scanner 112, and an output optical system 114 that controls the tilt angle from the road surface of a light beam that has passed through the optical scanner 113, for example. The light source 111 is connected to the ECU 130 via a LD drive circuit 115 and is configured to irradiate laser light according to a LD drive signal from the ECU 130. The optical scanner 113 may include a polygon mirror or a galvano mirror, for example, and is connected to the ECU 130 via an optical scanner drive circuit 116. The optical scanner 113 repetitively scans a light beam irradiated from the light source 111 in the horizontal direction at a predetermined frequency based on an optical scanner drive signal from the ECU 130. The scanning angle of the light beam from the optical scanner 113 is detected by a scanning angle monitor 117 and is output to the ECU 130 as a scanning angle signal. By supplying the scanning angle signal as feedback for the optical scanner drive signal, the scanning angle and the scanning frequency may be controlled.

The light receiving unit 120 includes a light receiving lens 121, a light receiving element 122, and a porous member 160. Laser light reflected by an object located ahead of the vehicle enters the light receiving element 122 via the porous member 160, the light receiving lens 121, and a mirror element (not shown), for example. The light receiving element 122 may be made of a photodiode, for example, and is configured to output an electric signal with a voltage corresponding to the intensity of the reflected light. The electric signal output from the light receiving element 122 is amplified by an amplifier 141 and output to a comparator 142. The comparator 942 compares the output voltage of the electric signal from the amplifier 141 with a reference voltage V0 and outputs a predetermined light receiving signal to a time measuring circuit 143 when the output voltage is greater than the reference voltage V0.

The time measuring circuit 143 also receives the LD drive signal that is output to the LD drive circuit 115 from the ECU 130 and outputs the time difference between the time point at which the laser light is irradiated and the time point at which the reflected light is received as time measurement data to the ECU 130. Based on the time measurement data, the ECU 130 may calculate the distance of the object from the laser radar apparatus. It is noted that the LD 111, the optical scanner 112, the input optical system 113, the output optical system 114, and the scanning angle monitor 117 may be referred to as a light irradiating unit 150.

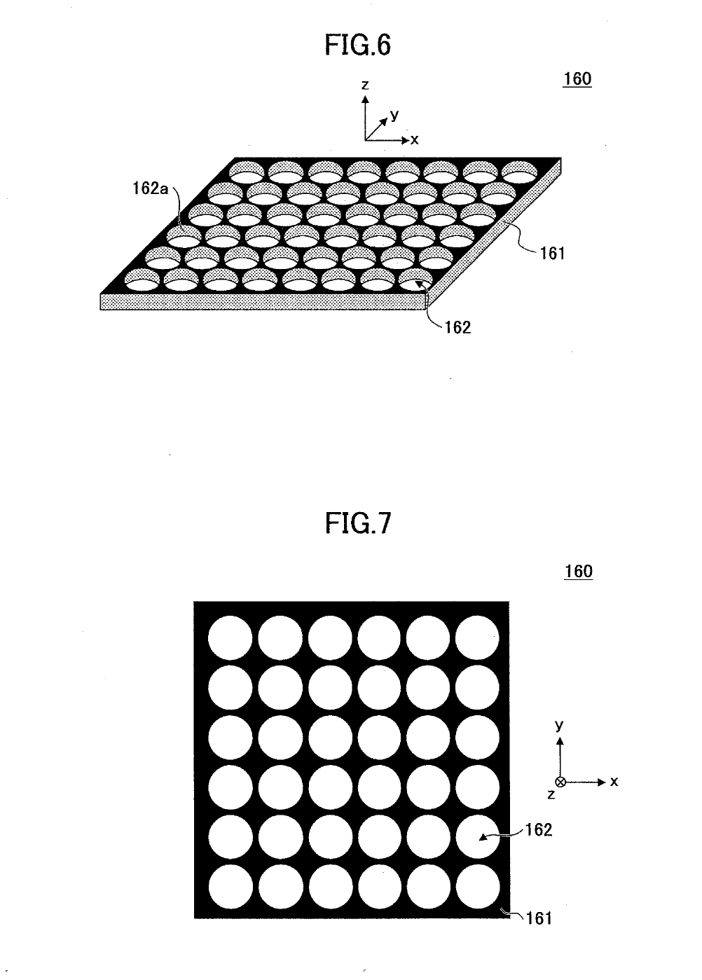

FIG. 6 is a perspective view and FIG. 7 is a plan view of the porous member of the laser radar apparatus according to the present embodiment. As is shown in FIGS. 6 and 7, the porous member 160 includes a parallel plate substrate 161 that has plural circular through holes 162 penetrating through the surface and the rear face of the substrate 161. The through holes 162 have side wall portions 162a that are arranged to be light-blocking walls so that light entering the side wall portions 162a of the through holes 162 may be blocked. In the present embodiment, the through holes 162 are arranged to penetrate through the substrate 161 in a substantially perpendicular direction with respect to the substrate 161. It is noted that the incidence angle of the light entering the porous member 160 is defined by the direction of the incident light and the direction of the normal line of the substrate 161 surface. The side wall portions 162a of the through holes 162 are preferably colored black or some other suitable color so that light entering the side wall portions 162a may be absorbed without being reflected or scattered. For example, the porous member 160 may be made of a light-absorbing black material such as carbon, or the porous member 160 including the sidewall portions 162a of the through holes 162 may be coated with a light-absorbing material. It is noted that although the through holes 162 are arranged to be circular in FIGS. 6 and 7, they may be oval or in some other shape. In the present embodiment, the through holes 162 are arranged at substantially equal intervals on the planar face of the substrate 161.

In the following, the functional features of the laser radar apparatus according to the present embodiment are described.

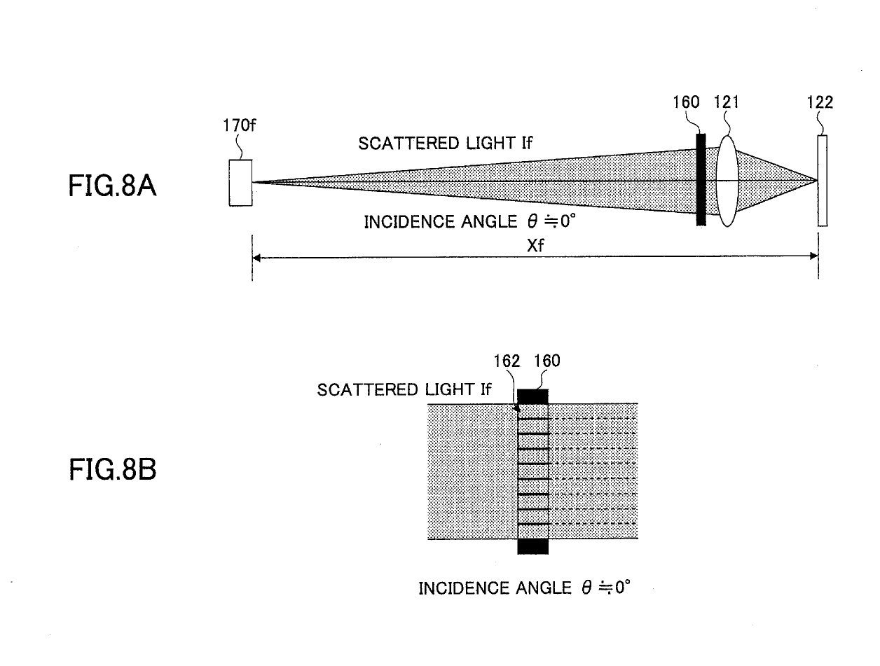

FIGS. 8A and 8B are diagrams illustrating scattered light If from an object 170f that is located relatively far away at a long distance Xf from the laser radar apparatus of the present embodiment. As is shown in FIG. 8A, the scattered light If scattered by the object 170f is substantially parallel. Thus, as is shown in FIG. 8B, the incidence angle θ of the scattered light If with respect to the porous member 160 is substantially equal to 0 degrees so that a large part of the scattered light If irradiated on the porous member 160 passes through the through holes 162 to enter the light receiving lens 121.

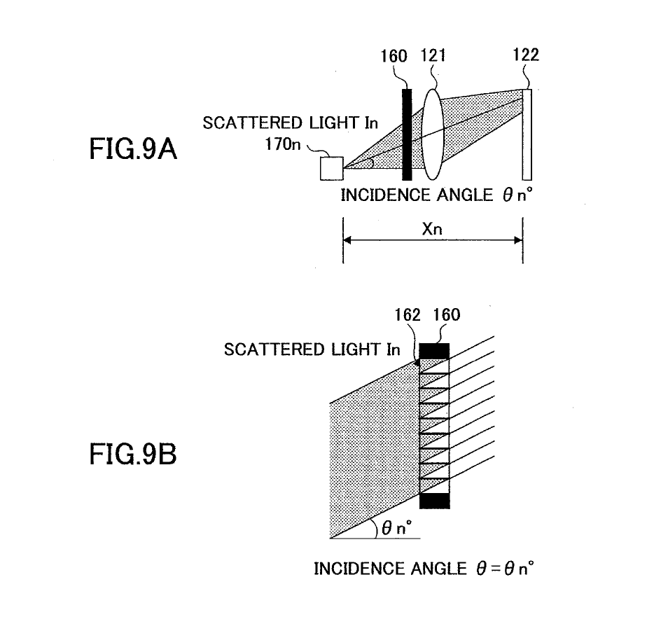

FIGS. 9A and 9B are diagrams illustrating scattered light In from an object 170n that is at a short distance Xn from the laser radar apparatus of the present embodiment. As is shown in FIGS. 9A and 9B, the scattered light In from the object 170n enters the porous member 160 at an incidence angle θ that is substantially equal to θ n degrees. In this case, a large part of the scattered light In irradiated on the porous member 160 is blocked by the side wall portions 162a of the through holes 162 so that only a small amount of light enters the light receiving lens 121.

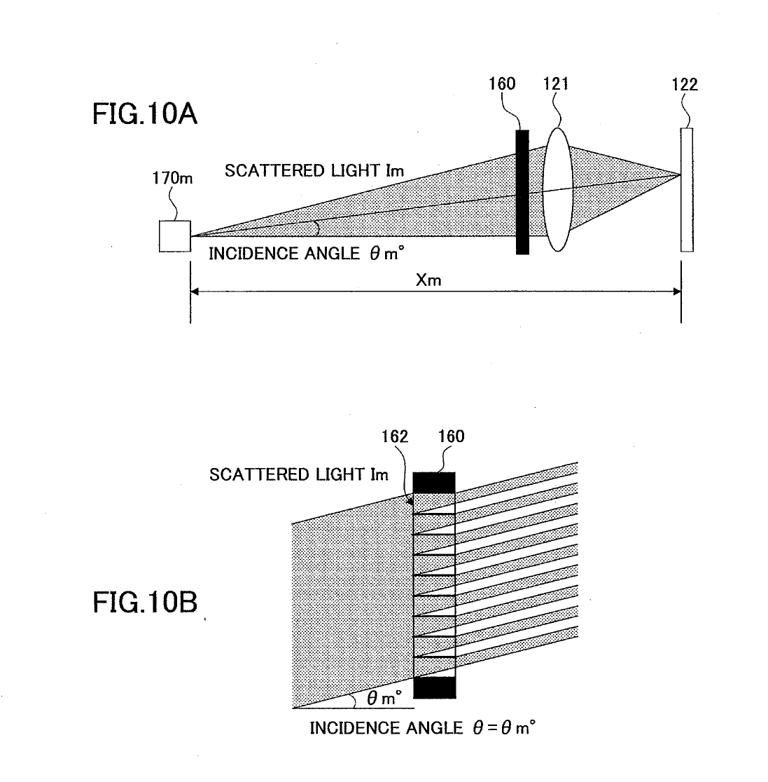

FIGS. 10A and 10B are diagrams illustrating scattered light Im from an object 170m that is located at an intermediate distance Xm that is longer than Xn but shorter than Xf from the laser radar apparatus according to the present embodiment. As is shown in FIGS. 10A and 10B, the scattered light Im from the object 170m enters the porous member 160 at an incidence angle θ that is substantially equal to θ m degrees. In this case, a part of the scattered light Im irradiated on the porous member 160 is blocked by the side wall portions 162a of the through holes 162 but the rest of the scattered light passes through the through holes 162 and enters the light receiving lens 121.

As can be appreciated from above, the relationship of the light intensities of the scattered lights If, Im, and In may be represented as follows: In intensity>Im intensity>If intensity. The relationship of the incidence angles of the scattered lights If, Im, and In may be represented as follows: 0<θm<θn.

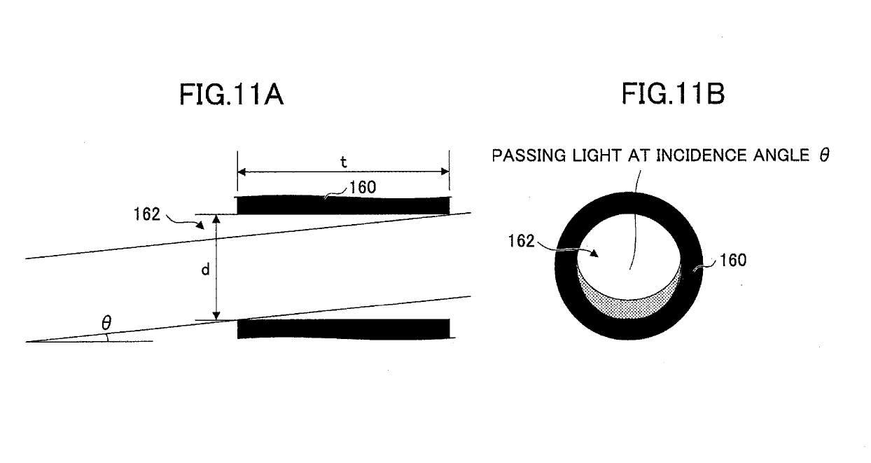

FIGS. 11A and 11B are a cross-sectional view and a plan view of one of the through holes 162 when scattered light enters the porous member 160 at an incidence angle θ. Assuming t denotes the thickness of the porous member 160; i.e., thickness of the substrate 161, the passing light intensity I of light that has passed through the porous member 160 may be expressed by Formula 1 shown below. It is noted that under Formula 1, the passing light intensity I equals 1 when the incidence angle θ is 0 degrees.

$$I = \frac{2 arccos ( \frac{t tan θ}{2 r} ) - sin \{ 2 arccos ( \frac{t tan θ}{2 r} ) \}}{π} \qquad [ Formula 1 ]$$

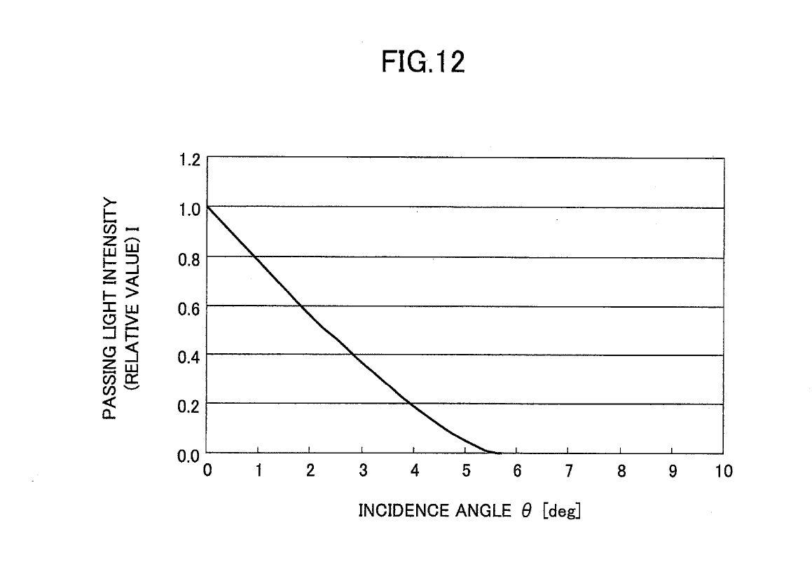

For example, FIG. 12 is a graph showing the relationship between the incidence angle θ and the passing light intensity I of scattered light in a case where the thickness t of the porous member 160 is 2 mm and the diameter d of the through hole 162 is 0.2 mm. As is shown in FIG. 12, the passing light intensity I decreases as the incidence angle θ of the scattered light increases. Accordingly, in the laser radar apparatus according to the present embodiment, when the object 170 is located relatively far away from the laser radar apparatus, the incidence angle θ of the scattered light from the object 170 is substantially equal to 0 degrees so that the passing light intensity I will remain substantially the same. However, when the object 170 is located relatively close to the laser radar apparatus, the incidence angle θ of the scattered light from the object 170 will be greater than zero so that the passing light intensity I will be weakened.

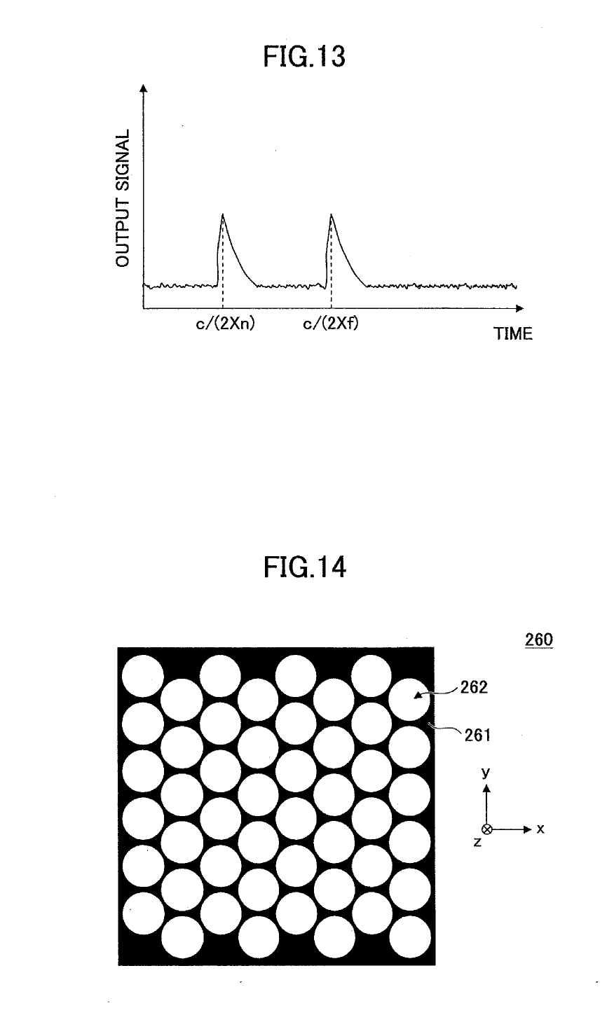

FIG. 13 is a graph showing output signals of an APD corresponding to the light receiving element 122 when scattered light is detected from an object located relatively far away from the laser radar apparatus and an object located relatively close to the laser radar apparatus.

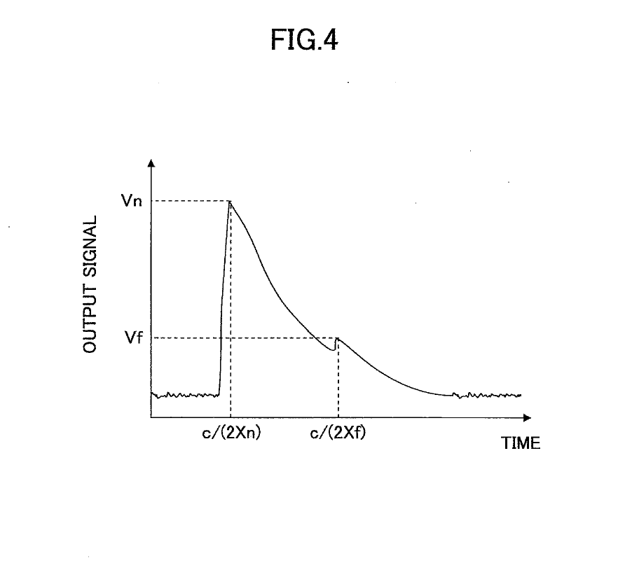

As can be appreciated from FIG. 4, in a laser radar apparatus that does not include the porous member 160, a high output signal Vn is output for the scattered light In from the object 970n that is located at a short distance Xn from the scanning laser radar apparatus since the intensity of the scattered light In is strong, whereas a low output signal Vf is output for the scattered light If from the object 970f that is located at a long distance Xf from the scanning laser radar apparatus since the intensity of the scattered light If is weak. In this case, the output signal Vn may overlap the output signal Vf. As a result, it may be difficult to measure the time difference for each of the output signals so that the time analysis performance and the distance measurement accuracy of the laser radar apparatus may be degraded.

However, in the laser radar apparatus according to the present embodiment, the intensity of the scattered light from the object 170n located close to the laser radar apparatus is weakened by the porous member 160 so that the output signal V of the light receiving element 122 may be lowered. Thus, the output signal for the scattered light from the object 170n located at a short distance Xn may be prevented from overlapping the output signal for the scattered light from the object 170f located at a long distance Xf. In turn, the time difference for each of the output signals may be accurately detected so that the time analysis performance and distance measurement accuracy of the laser radar apparatus may be improved. It is noted that c denotes the speed of light, c/(2×n) represents the time it takes for the light irradiated from the light irradiating unit 150 to be detected at the light receiving element 122 when the object 170n is located at a short distance Xn, and c/(2×f) represents the time it takes for the light irradiated from the light irradiating unit 150 to be detected at the light receiving element 122 when the object 170f is located at a long distance Xf.

### Second Embodiment

In the following, a laser radar apparatus according to a second embodiment of the present invention is described. In the present embodiment, the positions and shapes of the through holes arranged on the porous member differ from the first embodiment.

FIG. 14 is a plan view of a porous member 260 used in the second embodiment of the present invention. The porous member 260 has circular through holes 262 arranged on a substrate 261 at a relatively high density. In this way, scattered light entering the porous member 260 may be prevented from being blocked by portions of the porous member 260 other than the through holes 262. According to an aspect of the present embodiment, the overall passing light intensity may be increased, and shot noise may be decreased so that distance measurement of objects located farther away may be possible.

### First Modification

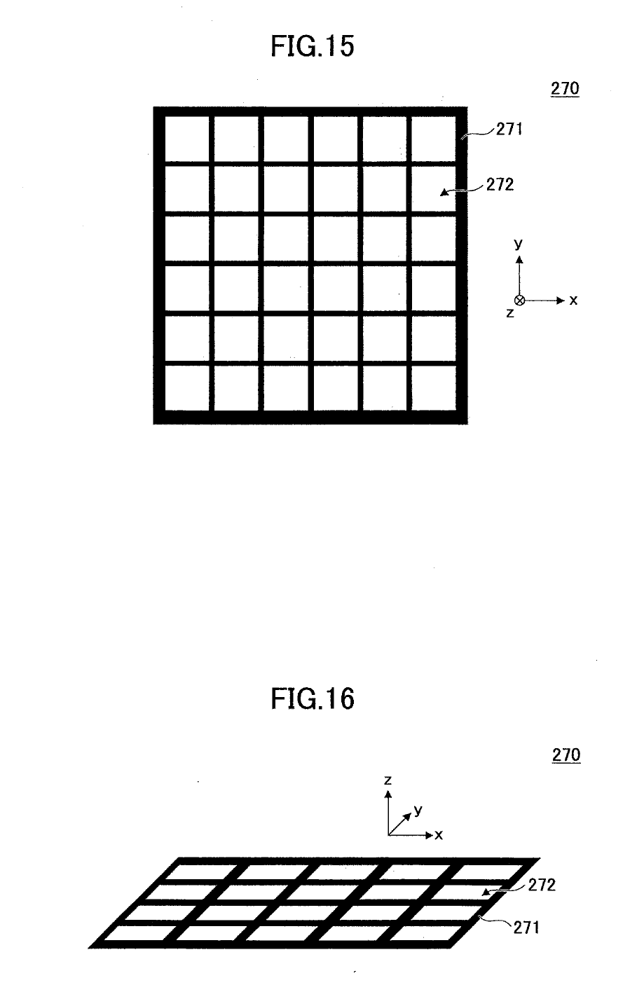

FIGS. 15 and 16 are a plan view and a perspective view of a porous member 270 according to a first modification of the second embodiment. As is shown in FIGS. 15 and 16, the porous member 270 includes a substrate 271 having rectangular through holes 272 arranged in a two-dimensional configuration. By arranging the through holes 272 to be rectangular, the overall passing light intensity may be further increased and distance measurement of objects located farther may be possible.

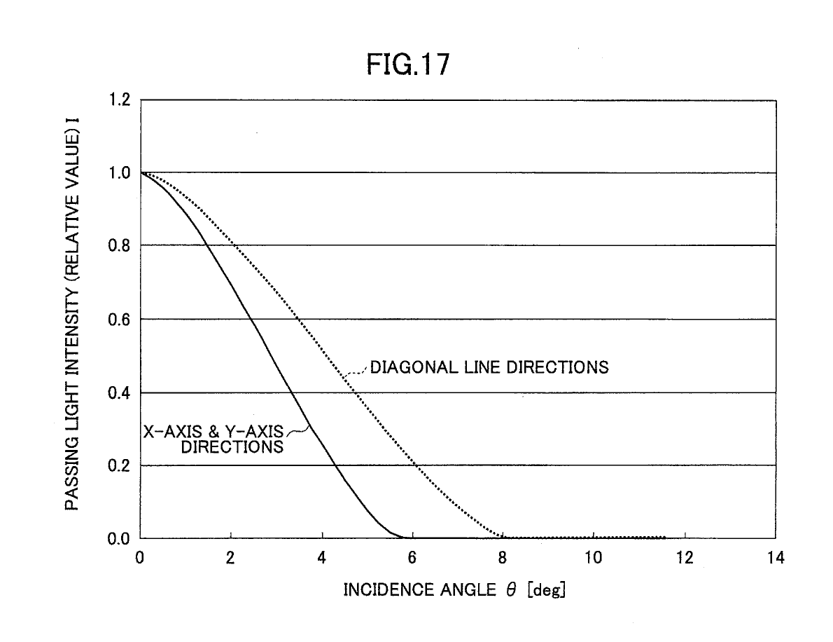

FIG. 17 is a graph showing the relationship between the incidence angle θ and the passing light intensity I of scattered light that has passed through the porous member 270. As is shown in FIG. 17, the dependency of the passing light intensity I on the incidence angle θ is different depending on whether the incidence angle θ varies in the X-axis and Y-axis directions (the incidence angle θ varies in the directions parallel to the sides of the through holes 272) and the case in which the incidence angle θ varies in the diagonal line directions (the incidence angle θ varies in the directions parallel to the diagonal lines of the through holes 272). In other words, the dependency of the passing light intensity I on the incidence angle θ varies depending on the direction in which the scattered light enters the through holes 272.

### Second Modification

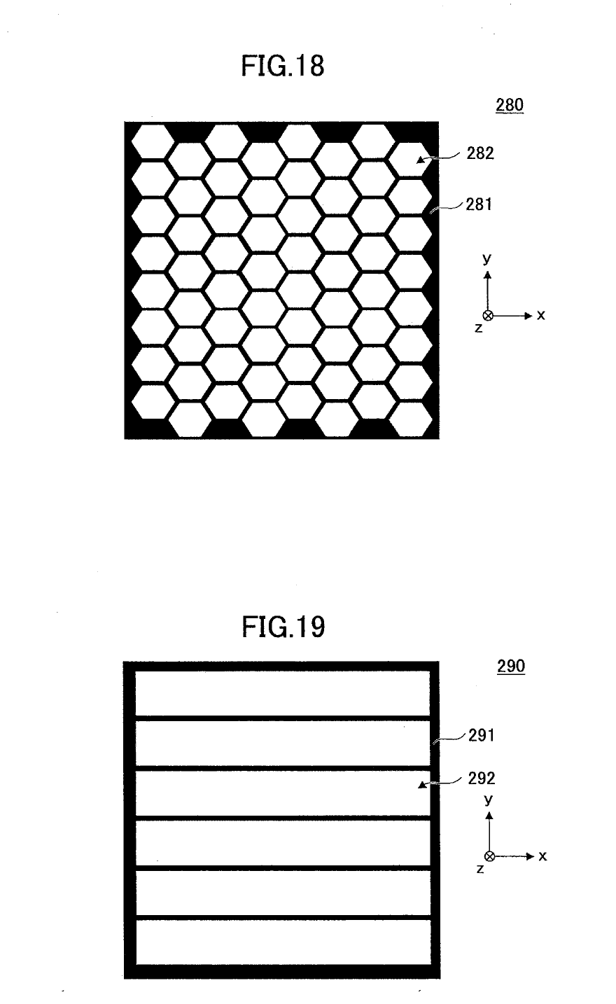

FIG. 18 is a plan view of a porous member 280 according to a second modification of the second embodiment. As is shown in FIG. 18, the porous member 280 includes a substrate 281 having hexagonal through holes 282 arranged in a two-dimensional configuration. That is, the through holes 282 of the porous member 280 are arranged into a honeycomb structure. By arranging the through holes 282 into such a structure, variations in the dependency of the passing light intensity I on the incidence angle θ may be contained. Also, by arranging the hexagonal through holes 282 into the honeycomb structure at a high density, the passing light intensity may be increased. It is noted that while the porous member according to the first modification is arranged to have rectangular through holes 272 and the porous member according to the second modification is arranged to have hexagonal through holes 282, other modifications are possible such as that in which the shapes of the through holes are arranged to be triangular, for example.

### Third Modification

FIG. 19 is a plan view of a porous member 290 according to a third modification of the second embodiment. As is shown in FIG. 19, the porous member 290 includes a substrate 291 having rectangular through holes 291 with one side arranged to be longer than the other side. In this modification, the sides of the through holes 292 in one direction and the sides of the through holes 292 in the other direction are arranged to intersect at right angles. By arranging the sides of the through holes 292 in one direction (X-axis direction) to be longer than the sides in the other direction (Y-axis direction), the passing light intensity I may only depend on the incidence angle θ of scattered light with respect to the XZ plane. By positioning the porous member 290 such that the X-axis direction of the through holes 292 is substantially parallel to the road surface, the passing light intensity of strong scattered light reflected and scattered by asphalt on the road surface may be adjusted, for example.

It is noted that other features of the second embodiment may be identical to those of the first embodiment so that their descriptions are omitted.

Further, the present invention is not limited to the above embodiments, and numerous variations and modifications may be made without departing from the scope of the present invention.

The present application is based on and claims the benefit of the priority date of Japanese Patent Application No. 2011-247884 filed on Nov. 11, 2011 with the Japanese Patent Office, the entire contents of which are hereby incorporated by reference.

What is claimed is

1. A laser radar apparatus comprising:
a light source;
a light scanning unit configured to scan light irradiated from the light source;
a light receiving unit configured to receive light that is reflected by an object, the light being irradiated from the light scanning unit onto the object and reflected by the object; and
a porous member arranged between the object and the light receiving unit, the porous member including a plurality of through holes.

2. The laser radar apparatus as claimed in claim 1, wherein
the through holes of the porous member are arranged in a two-dimensional configuration.

3. The laser radar apparatus as claimed in claim 1, wherein
the through holes are arranged to have a shape of at least one of a circle, an oval, a triangle, a rectangle, and a hexagon.

4. The laser radar apparatus as claimed in claim 1, wherein
the through holes are arranged to have a shape in which a side in one direction is longer than a side in another direction.

5. The laser radar apparatus as claimed in claim 1, wherein
the through holes include side wall portions that are configured to absorb light.

6. The laser radar apparatus as claimed in claim 1, wherein
the porous member includes a light absorbing material.

7. The laser radar apparatus as claimed in claim 1, wherein
the light irradiated from the light source includes a pulsed wave.

8. The laser radar apparatus as claimed in claim 1, further comprising:
a control unit configured to measure a distance of the object based on a time difference between a time point at which the light source irradiates the light on the object and a time point at which the light receiving unit receives the light reflected by the object.
